(19) United States
(12) Patent Application Publication
(10) Pub. No.: US 2005/0116968 A1
(43) Pub. Date: Jun. 2, 2005

(54) Multi-capability display

(76) Inventors: John Barrus, Menlo Park, CA (US); Kurt Piersol, Santa Cruz, CA (US); Stephen Savitzky, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/727,199

(22) Filed: Dec. 2, 2003

(51) Int. Cl. G09G 5/02

(52) U.S. Cl. 345/698

(57) ABSTRACT

An image is generated using two or more projectors, at least one of which displays the main display area and at least one of which is pointed and zoomed so as to display one or more windows in a region within the main display area. Windows are displayed at a higher resolution than the main display area, and/or including additional display capability or characteristics beyond those of the main display area. Windows are movable and resizable according to known techniques of window manipulation in conventional graphical user interfaces. A control mechanism associated with each window projector moves and resizes the displayed images generated by window projectors in response to such window manipulation.

### FIELD OF THE INVENTION

The present invention relates generally to display systems, and more specifically to multi-projector display techniques for combining displayed images having different levels of resolution and/or other characteristics.

### BACKGROUND OF THE INVENTION

Large, high-resolution displays allow a user to do detail work in a larger context than is generally available with standard-sized displays. For instance, maps are typically large, and also contain a great amount of detail. A large high-resolution display provides both focus and context, by showing street-level details clearly while also revealing the location of the neighborhood within the city.

However, the cost of creating large, high-resolution displays is prohibitive. Most large displays are somewhat low-resolution (about 20 pixels per inch); they are suitable for presenting information to a large group, but less useful for detailed work.

In addition, in some situations it is desirable to provide advanced functionality or features for a portion of an image that currently has focus, without necessarily providing such functionality for the entire image. For example, it may be desirable to provide a full-motion video in a portion of the image, without necessarily enabling such capability for the entirety of the image, due to the cost-prohibitiveness or unwieldiness of doing so.

What is needed is a display system and method that provides, at reasonable cost, a large display, and further provides high resolution to facilitate detail work. What is further needed is a display system and method that provides a large display containing a region in which advanced functionality or features are enabled, without necessarily enabling such advanced features in the remainder of the large display. What is further needed is a display system and method that provides these advantages without requiring the user to perform additional actions or commands beyond normal window manipulation that is done in the context of user interface interaction.

### SUMMARY OF THE INVENTION

The present invention combines a main image, which may be of relatively low resolution, with one or more windows which are presented in relatively high resolution and/or which have one or more advanced features not found in the main image. In one embodiment, the final image is generated using two or more projectors, at least one of which displays the main display image and at least one of which is pointed and zoomed to display one or more windows in a region within the main display image area.

In one embodiment, the main display image is of relatively low resolution. One or more windows are provided, which are smaller, movable, zoomable areas within the main display image area. One or more of these windows are displayed at a higher resolution than the main display image. Alternatively (or in combination with the high-resolution capability), one or more windows may have additional display capability beyond that of the main display image. For example, a window may have the capability to display full-motion video whereas the main display image may not. A window may have color capability whereas the main display image may be monochrome (black-and-white). Other examples and variants will be apparent to one skilled in the art.

In one embodiment, the invention is implemented by providing a main projector, or “workspace projector”, that displays the main display image on a large screen. In one or more regions, the workspace projector leaves holes or blank areas where no light is projected on the screen. One or more window projectors display the high-resolution work areas within the blank areas. The window projectors are moveable and zoomable so that they can be directed toward specific locations on the screen.

In one embodiment, window regions follow an on-screen window that is currently accepting input or is currently the top-most window. For purposes of the description herein, such a window is referred to as having focus, or being the focus window. Thus, in a multi-window operating system, the window currently having focus is displayed at high resolution, while the remainder of the screen is displayed at lower resolution. If the window having focus is moved or resized, the window projector adjusts the position and/or size of the displayed high-resolution area accordingly, and the workspace projector moves and/or resizes its blank area accordingly. If a different on-screen window is given focus, the window projector starts displaying that window instead of the window that previously had focus; the workspace projector adjusts its image accordingly as well.

### BRIEF DESCRIPTION OF THE DRAWINGS

The accompanying drawings illustrate several embodiments of the invention and, together with the description, serve to explain the principles of the invention.

FIG. 1 depicts an example of an arrangement of projectors to generate a composite image according to one embodiment of the present invention.

FIG. 2 depicts an example of a composite image containing a main image and two windows.

FIG. 3 depicts an example of a pan/tilt mechanism, coupled to a high-resolution projector for generating a high-resolution component of the composite image according to one embodiment of the present invention.

FIG. 4 depicts an example of a composite image having two levels of resolution.

FIG. 5 depicts a detail of an area of the composite image of FIG. 4.

FIG. 6 depicts an example of output from a lower-resolution projector for generating a workspace component of the composite image.

FIG. 7 depicts an example of a transition from one focus window to another, according to one embodiment.

FIG. 8 depicts an example of an embodiment using multiple lower-resolution projectors and multiple high-resolution projectors.

FIG. 9 depicts an embodiment wherein a flat-panel display is used instead of a workspace projector.

### DETAILED DESCRIPTION OF THE EMBODIMENTS

The present invention is now described more fully with reference to the accompanying Figures, in which several embodiments of the invention are shown. The present invention may be embodied in many different forms and should not be construed as limited to the embodiments set forth herein. Rather these embodiments are provided so that this disclosure will be complete and will fully convey the invention to those skilled in the art.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems may be used with programs in accordance with the teachings herein, or it may prove convenient to construct more specialized apparatuses to perform the required method steps. The required structure for a variety of these systems will appear from the description below. In addition, the present invention is not described with reference to any particular programming language. It will be appreciated that a variety of programming languages may be used to implement the teachings of the invention as described herein. Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

In one embodiment, the present invention generates a composite image including at least one low-resolution component and at least one high-resolution component. The following description sets forth the invention in terms of such an embodiment. However, one skilled in the art will recognize that other variants of the invention are possible, including those in which the composite image includes components having differing characteristics other than resolution levels; for example, the composite image may include at least one monochrome component and at least one color component. Accordingly, the following description, which refers to differing resolution levels, is intended to be illustrative of merely one example of an embodiment, and should not be considered to limit the invention to generation of composite images having differing resolution levels.

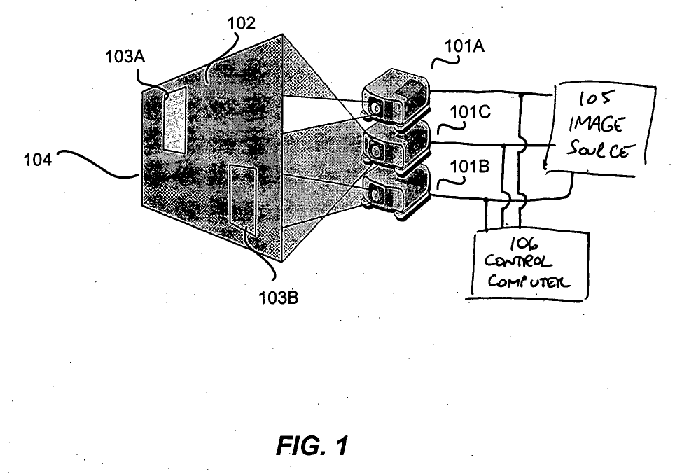

Referring now to FIG. 1, there is shown an arrangement of projectors 101A-C according to one embodiment of the present invention, to generate composite image 104. A desktop version of the invention would comprise a desk-like projection surface with projectors 101A-C embedded in the desk (not shown). Projectors 101A-C are connected to image source 105, which may be a frame buffer, computer, video source, or the like. Image source 105 provides the image that is to be displayed by projectors 101A-C. Although one image source 105 is shown in FIG. 1, one skilled in the art will recognize that any number of image sources 105 can be provided in connection with the present invention. For example, one projector 101A may obtain its image from one image source 105, whereas another projector 101B may obtain its image from a different image source 105. In another embodiment, image source 105 uses a common image and divides it into component parts, each of which is to be displayed by one of projectors 101A-C; image source 105 then transmits the appropriate component part of the image to each of projectors 101A-C. Projectors 101A-C are also connected to a control computer 106 for controlling the position and zoom of each projector 101A-C.

One projector 101C (also referred to herein as a “workspace projector”) projects the workspace display image 102, for example a display area having dimensions of five feet by three feet and having resolution of 1280 pixels by 768 pixels (approximately 21 pixels per inch resolution). In the example shown, two additional projectors 101A and 101B project windows 103A and 103B at higher resolution (for example, 1280 pixels by 1024 pixels). Depending on the size of windows 103A and 103B, the resolution in pixels per inch for these areas can be significantly higher than the resolution of workspace display image 102. For example, for a window size of 14 inches by 12 inches, the resolution within the window would be approximately 85 pixels per inch. In general, each window 103A, 103B is smaller in size than overall image 104.

As described in more detail below, windows 103A and 103B are movable and resizable, either by moving and/or adjusting projectors 101A and 101B or by moving and/or adjusting optical apparatuses, such as mirrors and zoom lenses.

In one embodiment, workspace projector 101C does not display anything in the area occupied by windows 103A and 103B, leaving blank areas or “holes” so as to avoid overlapping with the images generated by window cameras 101A and 101B. The particular characteristics of such blank areas depend on the display technology being used, so as to ensure that there is no interference with displayed windows 103A, 103B. For instance, when using projectors and a screen, workspace projector 101C shines no light in areas corresponding to windows 103A, 103B, since such light could interfere with the image projected by high-resolution projectors 101A, 101B. In embodiments where a display device other than a projector is used to display workspace display image 102, such as for example a liquid crystal display (LCD) screen or organic light-emitting diode (OLED) display screen, the LCD or OLED elements in areas corresponding to windows 103A, 103B are turned off, again so as not to interfere with the image of workspace display image 102. Throughout this specification, the area where no image is projected, or where a neutral color is projected so as not to interfere with another projector, is referred to as a “blank” area. Workspace projector 101C moves and resizes these blank areas in conjunction with the movement and resizing of windows 103A and 103B.

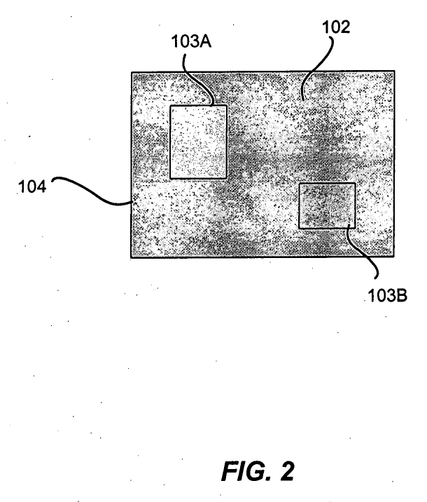

Referring now to FIG. 2, there is shown an example of a composite image 104 containing a workspace display image 102 and two windows 103A and 103B, as might be generated by the projector arrangement shown in FIG. 1.

The examples of FIGS. 1 and 2 depict an arrangement wherein two windows 103A and 103B are displayed as part of overall image 104. However, one skilled in the art will recognize that the present invention can be used in connection with one window, or with any number of windows. In one embodiment, one projector 101 is provided for each window, and one projector 101 (the “workspace projector”) is used to generate workspace display image 102. In another embodiment, one projector 101 is provided for generating two or more windows 103A, 103B, and one projector 101 (the “workspace projector”) is used to generate workspace display image 102. In yet another embodiment, two or more projectors 101 can be used for windows, and two or more projectors 101 can be used to generate the workspace display image 102, according to known techniques for employing multiple projectors to construct a single image.

According to one embodiment, the invention is used for displaying a screen having one or more windows, as in a conventional graphical user interface. A window projector 101A is used to display the currently active window (i.e., the window that currently has focus, also referred to herein as the “focus window”); all other windows (if any) are displayed by workspace projector 101C. If the user changes focus, for example by clicking on another window on the screen to make it the active window, workspace projector 101C takes over the task of displaying the previously active window, allowing window projector 101A to pan and zoom over to the location of the newly selected window. Once oriented correctly, window projector 101A takes over the display of the newly active window, and workspace projector 101C displays nothing within the region occupied by the newly active window.

In one embodiment, the present invention is implemented using one or more projectors such as the LP250 from InFocus of Wilsonville, Oreg. In one embodiment, the image is projected onto one or more projection screens such as those available from Rose Brand of New York, N.Y.

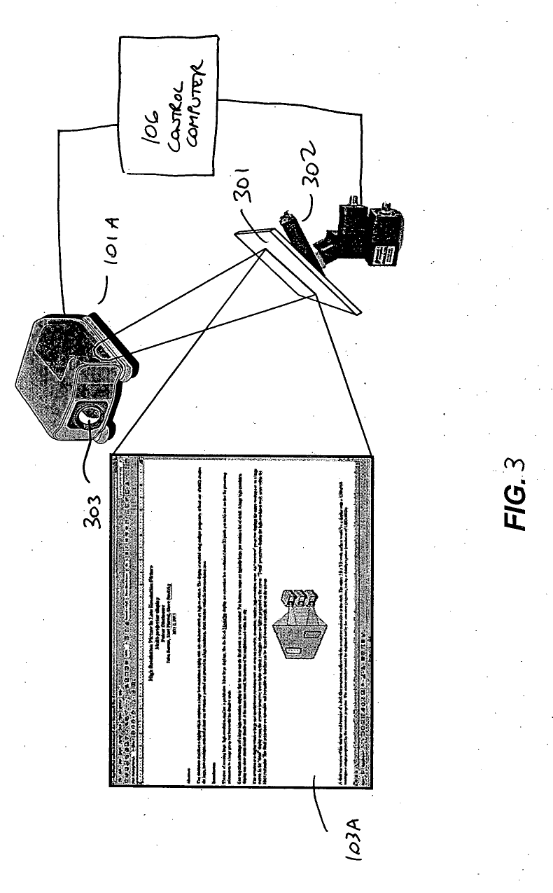

Referring now to FIG. 3, there is shown an example of a pan/tilt mechanism 302 according to one embodiment of the present invention. In one embodiment, instead of moving the entire display mechanism of projector 101A (and other projectors), a mirror 301 is mounted on a pan/tilt mechanism 302 and placed in such a way that the image from projector 101A is reflected onto the screen in the appropriate location. Pan/tilt mechanism 302 is coupled to and controlled by control computer 106. If the high-resolution window is resized, in one embodiment projector 101A is moved closer or farther away from the screen. Alternatively, projector 101A may include zoom lens mechanism 303 allowing the image projected from projector 101A to be made larger or smaller as needed. Both zoom lens mechanism 303 and pan/tilt mechanism 302 can be motorized and steered in such a way that the high-resolution window image from projector 101A appears in the correct location and at the correct size in the workspace image.

In one embodiment, the configuration of pan/tilt mechanism 302, and the location of projector 101A are established such that the image from projector 101A can be steered to any location in the workspace image. Control computer 106, after determining the location of the high-resolution window, calculates the correct angle and zoom of pan/tilt mechanism 302 and zoom lens mechanism 303. Motors in pan/tilt mechanism 302 and zoom lens mechanism 303 are activated to drive each device to the proper position, allowing the window to be resized and located properly. When the high-resolution window is to be moved, new values for the pan/tilt and zoom are calculated, and the devices are moved to the new, correct positions. In one embodiment, pan/tilt mechanism 302 is implemented using a PTU-46-17.5 high-speed pan/tilt unit, available from Directed Perception of Burlingame, Calif., along with appropriate software for controlling pan/tilt angles. In one embodiment, projector 101A includes a motorized zoom lens 303; alternatively, a motor can be added to a mechanical zoom lens on an existing projector. Driving mechanical systems with a computer-controlled motor is well understood in the art.

If projector 101A lacks a zoom lens, it can be placed closer to the screen than the workspace projector 101C. In this way, the resolution of the image coming from projector 101A will be higher than the image from the workspace projector 101C. Smaller windows can be projected by restricting the displayed image to a subset of the total display area of the projector and blacking out or turning off the pixels outside of the smaller window.

In one embodiment, adjustments are made to window 103A from projector 101A so as to account for “keystoning.” Keystoning is a well-known phenomenon wherein images on a screen formed by a projector are distorted if the projector and screen are not perfectly aligned. For instance, as the front of the projector is elevated, the top part of the projected image appears to widen. This is due to the increased distance from the lens to the screen at the top of the image. Most projectors have electronic adjustments to counter the keystoning effect; one example is the Canon LV-7215 projector made by Canon USA, Inc. of Lake Success, N.Y., USA.

When window 103A from projector 101A is moved from one location to another, in one embodiment window 103A is “de-keystoned” so that it remains rectangular on the screen. There are well-known ways of de-keystoning, including for example redrawing the window so that edges of the window that would be elongated are shortened before they are displayed. In other words, the window being projected is distorted in such a way as to counter the keystoning effect, so that the final window 103A is rectangular. Since different types and degrees of keystoning may occur depending on the position and size of window 103A, this de-keystoning operation may be performed every time window 103A is moved or resized. Where appropriate, similar adjustments are made to the blank area of workspace display image 102, projected by projector 101C.

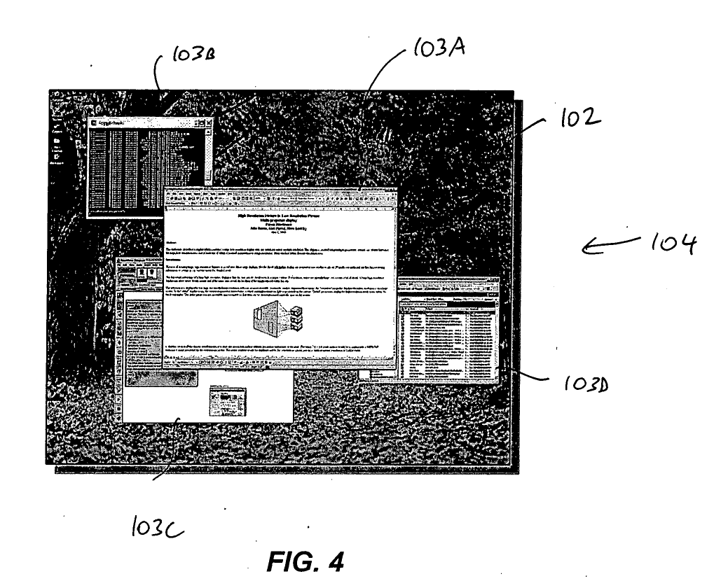

Referring now to FIG. 4, there is shown an example of a composite image 104 generated by an embodiment of the present invention. Image 104 includes window 103A, which currently has focus and is displayed at high resolution. Image 104 also includes workspace display image 102 and windows 103B, 103C, 103D, which do not currently have focus and are displayed at lower resolution.

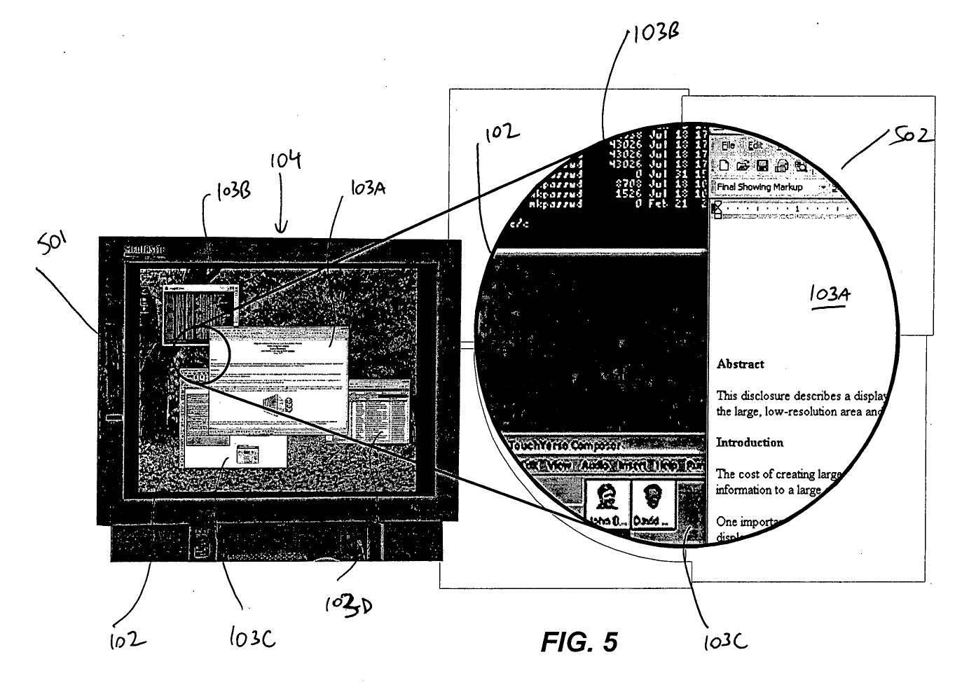

Referring now to FIG. 5, there is shown an enlarged detail 502 of an area 501 of composite image 104, for illustrative purposes. It can be seen from detail 502 that window 103A is presented at higher resolution than are windows 103B, 103C, and workspace display image 102. The invention thus provides higher resolution for that section of image 104 that is currently of greatest importance, namely window 103A, without requiring a large high-resolution display of entire image 104.

As described above, in one embodiment a composite image 104 such as that shown in FIG. 4 is generated using two projectors: a workspace projector 101C for displaying workspace display image 102, and a second, high resolution projector 101A for displaying window 103A. One skilled in the art will recognize that workspace projector 101C is not necessarily of lower resolution than projector 101A; however, since the image generated by workspace projector 101C covers a larger area than the image generated by projector 101A, in general the effective resolution of the image generated by projector 101A will have a higher degree of resolution.

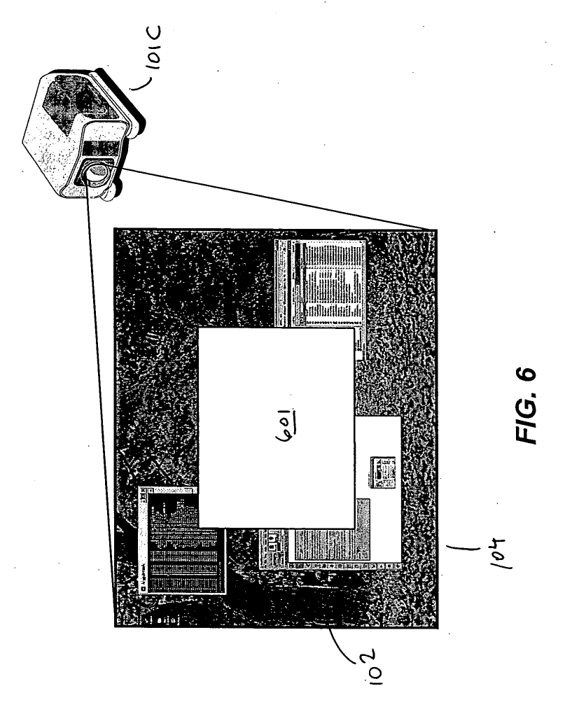

Referring now to FIG. 6, there is shown an example of workspace display image 102 displayed by workspace projector 101C. Workspace display image 102 includes all areas of image 104 other than the region occupied by window 103A of FIG. 4. Area 601, corresponding to the location of window 103A of FIG. 4, is left blank, as described above, so as not to interfere with the image from high-resolution projector 101A (not shown in FIG. 6). Area 601 is shown white in the Figure for clarity; however, as described above area 601 is generally colored black or whatever color does not interfere with the display of high-resolution windows.

Referring again to FIG. 3, there is shown an example of high-resolution projector 101A displaying window 103A. Control computer 106 controls mirror 301 to place window 103A in the appropriate location. Thus, window 103A overlays area 601 generated by workspace projector 101C, so as to form composite image 104 as shown in FIG. 4. Since projector 101A is dedicated to displaying window 103A and need not display other portions of image 104, the resolution of window 103A can be maximized.

When focus changes from one window 103 to another, for example in response to a user clicking on a window 103 other than the one that currently has focus, high-resolution projector 101A switches to display the window 103 that has been given focus. If appropriate, the image generated by projector 101A is moved (by, for example, using control mechanism 302 to move mirror 301) so that the image is properly positioned at the location of window 103 that currently has focus.

Focus can change from one window 103 to another in response to other types of events as well. For example, a window 103 may become active in response to some event either internal or external to the operation of the computer, such as when a new window is created because new output becomes available, or a new dialog box is displayed, or a message in the window changes and is of sufficient importance that it is to be shown in high resolution.

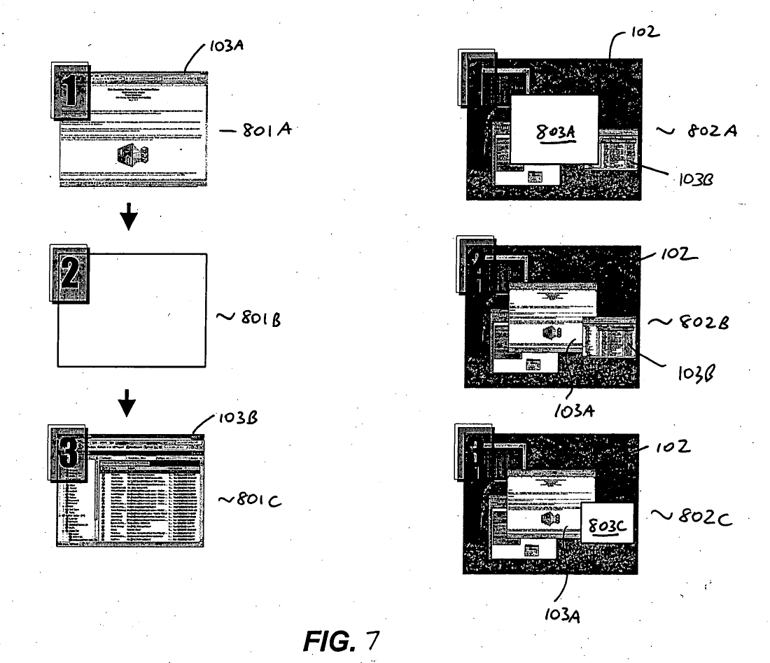

Referring now to FIG. 7, there is shown an example of a technique for transitioning from one focus window to another, according to one embodiment. In the example of FIG. 7, images 801A, 801B, and 801C are generated by high-resolution projector 101A at different times, and images 802A, 802B, and 802C are generated by workspace projector 101C at respective different times.

Initially, in the example of FIG. 7, window 103A has focus. Workspace projector 101C displays image 802A, including all windows and background except for window 103A. The area corresponding to the position of window 103A is left blank, leaving a place for projector 101A to display window 103A. Projector 101A displays image 801A corresponding to window 103A in the area left blank by projector 101C. Area 803A is shown white in the Figure for clarity; however, as described above area 803A is generally colored black or whatever color does not interfere with the display of high-resolution windows. The combination of images 801A and 802A yields a complete image wherein window 103A has focus and is displayed at high resolution.

In response to the user indicating that window 103B should be given focus, for example by clicking on window 103B using a cursor or pointing device, high-resolution projector 101A stops displaying window 103A, possibly by turning off the projection completely. Control computer 106 causes zoom lens mechanism 303 and pan/tilt mechanism 302 to adjust (and mirror 301 to be repositioned) so that projector 101A can properly display window 103B instead. While zoom lens mechanism 303 and pan/tilt mechanism 302 are in transition, image 802B is displayed by the workspace projector 101C. Image 802B is complete in that all windows, including 103A and 103B, are shown, and no blank or neutral areas are left to be displayed by high-resolution projector 101A. In one embodiment, image 801B (an all-blank image) is transitional and is displayed for only a brief period of time while mirror 301 is repositioned.

Once mirror 301 and zoom lens mechanism 303 are in position, images 801C and 802C can be displayed. Since window 103B now has focus, high-resolution projector 101A begins to display window 103B at high resolution as shown in 801C. Workspace projector 101C displays image 802C, including workspace component 102. Workspace display image 102 now includes all areas of the image other than area 803C, corresponding to the position of window 103B. Workspace projector 101C leaves area 803C blank. The combination of images 801C and 802C yields a complete image wherin window 103B has focus and is displayed at high resolution.

Of course, one skilled in the art will recognize that two or more high-resolution projectors 101 can be provided, so that both windows 103A and 103B can simultaneously be displayed at high resolution. In such an embodiment, a switch in focus may not necessarily cause a projector 101A to be repositioned or to change the window it is displaying.

When a user moves or resizes a window 103 that currently has focus, control computer 106 moves mirror 301 and zoom lens mechanism 303 so that projector 101A can continue to display the window 103 having focus. In one embodiment, the resolution of the focus window 103 is adjusted based on the current size of the window 103, so that maximum use is made of the capabilities of the high-resolution projector. For example, the total number of pixels presented in window 103 can be held constant, so that when window 103 is made smaller, effective resolution per unit screen area is increased.

Concurrently, the blank portion of workspace display image 102 generated by workspace projector 101C is moved so that projector 101C leaves blank the area of the display corresponding to the window 103 that has focus.

The present invention provides several advantages over prior art techniques. As indicated, it provides high-resolution for large-scale displays, while avoiding the prohibitive cost of providing high-resolution over the entire display. It integrates well with existing window-based user interfaces, wherein a particular area of a screen (a window having focus) is known to be of greater interest to the user than the rest of the screen. In addition, the border between the focus window and the adjacent area of the screen provides a natural boundary that minimizes the discontinuity between the higher- and lower-resolution displays.

The high-resolution portion of the display moves naturally and in an intuitive manner when the user moves or resizes the window having focus, or when the user changes focus to another window; thus the user need not learn any new techniques in order to operate the invention. The user need not explicitly specify or designate a particular area of the screen image 104 to be displayed at high resolution, and need not move a focus window (not shown) to any particular area of the screen in order to see it in high resolution. Rather, the appropriate area to display at high resolution is implicit in the user's activation of a window, an operation that is commonly made in the normal course of interaction with a window-based user interface. Control mechanism 302 is driven by window manager move/resize/pop requests, as provided by conventional operating systems, so that the invention can be easily integrated with existing window management software. By adjusting resolution based on the current size of the window, maximum use is made of the capabilities of the high-resolution projector.

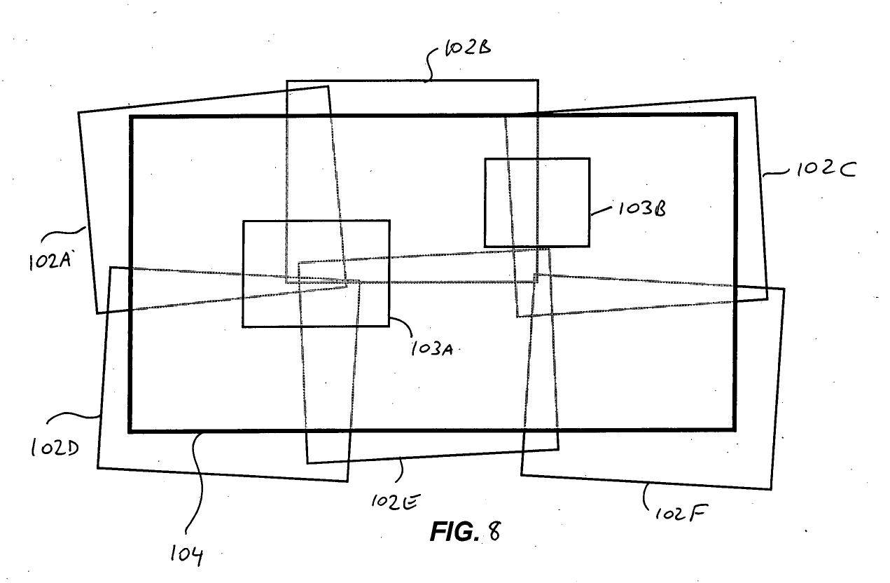

One skilled in the art will recognize that many variants and alternative embodiments are possible. For example, referring now to FIG. 8, there is shown an embodiment using multiple workspace projectors and multiple high-resolution projectors. The main display image 104 is divided into six sections 102A-F, which may or may not overlap. Each section 102A-F is generated by a different workspace projector (not shown in FIG. 8). Additional high-resolution projectors (not shown in FIG. 8) generate the display of windows 103A and 103B. The six workspace projectors leave blank the areas corresponding to windows 103A and 103B. Thus, the combination of six workspace projectors and two high-resolution projectors generates the final image 104.

One advantage of a display as shown in FIG. 8 is that windows 103A and 103B are seamless. Thus, even if a transition, or seam, is visible between sections 102A-F projected by workspace projectors, the seam is eliminated from those areas of the image that are of prime importance (windows 103A and 103B). FIG. 8 is therefore exemplary of a technique using the principles of the present invention that can be extended to create very large displays wherein certain key portions of the display are shown at high resolution.

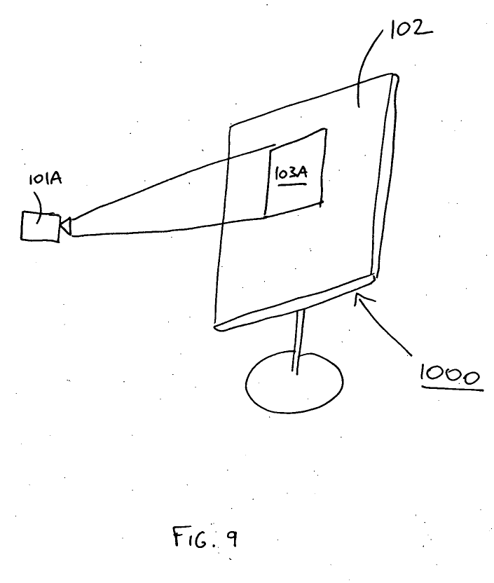

Referring now to FIG. 9, there is shown an embodiment wherein a flat-panel display 1000 (or other display technology) is used instead of workspace projector 101C. Window projector 101A projects window 103A onto the surface of display 1000. Display 1000 leaves blank the area occupied by window 103A, in the same manner as described above for workspace projector 101C. As described above, control mechanism 302 (not shown in FIG. 9) is used to move and resize the output of projector 101A, and display 1000 moves its blank area accordingly. As described above, more than one window projectors, such as 101A, can be used.

Other variations are possible, as will be apparent to one skilled in the art. For example, in one embodiment, rather than (or in addition to) providing a higher degree of resolution, window projector 101A can provide some other characteristic, capability, or feature that is not provided by workspace projector 101C. For example, it may be desirable to display, in window 103A, motion picture output from a video source (such as a DVD player), while the remainder of workspace display image 102 is output from a computer source. Window projector 101A provides the video output in window 103A, while workspace projector 101C displays the remainder of workspace display image 102, leaving blank the area occupied by window 103A. As described above, window 103A can be movable and resizable, so that control mechanism 302 is employed to move the image presented in window 103A according to such movements and resizing. Similarly, as described above, the blank area is moved accordingly.

As will be apparent to one skilled in the art, window projector 101A can provide other characteristics, capabilities, or features not provided by workspace projector 101C. For example, window projector 101A might have color capability, while the remainder of workspace display image 102 is shown in monochrome. Alternatively, window projector 101A might have any other visual characteristic that is not provided by window projector 101A. Thus, when color (or another visual characteristic) is desirable but too expensive for the entire image, the present invention allows color to be provided in those areas of the screen currently having focus, without wasting such capability on the rest of the image.

One potentially useful application is to provide a system for radiologists and doctors to read X-rays. X-rays are high-resolution, high-contrast monochrome images. Other user interface elements that may be appropriate to display on-screen along with X-rays are more suitable for color display. In one embodiment, therefore, a monochrome projector providing high-resolution, high-contrast images for the X-rays is employed for displaying one or more windows, whereas the workspace display image is displayed in color at a lower resolution.

Other embodiments are also possible. In some embodiments, the invention is implemented in such a way that it operates independently of any on-screen windows, and can operate in the absence of any on-screen windows. In such embodiments, regions 103A and 103B (as shown in FIG. 1), represent areas within image 104 that are not windows and do not necessarily correspond to windows. If desired, no window border need be displayed at the edges of regions 103A and 103B. Positions and sizes of regions 103A and 103B can be controlled by user operation of a pointing device or other input device, which causes control computer 106 to reposition and re-zoom projectors 101A and 101B accordingly.

Such embodiments operate in a similar manner to the techniques described above, with projectors 101A, 101B projecting images for regions 103A and 103B, and projector 101C projecting workspace display image 102. Regions 103A and 103B may be of higher resolution than workspace display image 102, or they may have some other characteristic not present in workspace display image 102. Image source 105 provides the image that is to be displayed by projectors 101A-C. As described above, more than one image source 105 may be provided; for example, projector 101A may obtain its image from a regional image source 105, projector 101B may obtain its image from another regional image source 105, and projector 101C may obtain its image from a workspace image source 105.

According to one example of such an embodiment, projector 101A projects an infrared camera image in region 103A, while projector 101C projects a visible-light workspace display image 102 (leaving blank the area occupied by region 103A).

According to another example, workspace projector 101C displays a panoramic image (such as one from a panoramic video camera), leaving an area blank. Projector 101A displays an image in the blank area from a different video source trained at a portion of the panoramic area such that a higher-resolution (or higher-frame rate) view of the area is displayed in region 103A.

In either of these examples, the system can be implemented without showing a visible border around region 101A, so that region 103A is an arbitrary area of overall image 104.

It will be understood by those skilled in the relevant art that the above-described implementations are merely exemplary, and many changes can be made without departing from the true spirit and scope of the present invention. Therefore, it is intended by the appended claims to cover all such changes and modifications that come within the true spirit and scope of this invention.

1. A multi-projector display system for displaying an image including at least one window, comprising:
a window projector, for displaying, at a display location, a portion of the image corresponding to a movable window;
a workspace projector, for displaying the remainder of the image; and
a control mechanism, coupled to the window projector, for changing at least one of the display location and the size of the window portion of the image.

2. The display system of claim 1, wherein the control mechanism changes the at least one of the display location and the size of the window portion of the image in response to a user command.

3. The display system of claim 1, wherein the control mechanism changes the display location of the window portion of the image in response to a user command for moving the window.

4. The display system of claim 1, wherein the control mechanism changes the display location of the window portion of the image in response to activation of the window.

5. The display system of claim 1, wherein:
the window projector displays the window portion of the image at a first level of resolution; and
the workspace projector displays the remainder of the image at a second level of resolution.

6. The display system of claim 5, wherein the first level of resolution is greater than the second level of resolution.

7. The display system of claim 1, wherein:
the window projector displays the window portion of the image in a first visual format; and
the workspace projector displays the remainder of the image in a second visual format;
wherein the first visual format is distinct from the second visual format.

8. The display system of claim 7, wherein the first visual format is color and the second visual format is monochrome.

9. The display system of claim 1, wherein the window projector displays a motion picture in the window portion of the image.

10. The display system of claim 1, wherein the window projector and the workspace projector are coupled to a common image source.

11. The display system of claim 1, wherein the window projector is coupled to a first image source, and the workspace projector is coupled to a second image source.

12. The display system of claim 1, wherein the image includes a plurality of windows, one of the windows currently having focus, and wherein the window projector displays the portion of the image corresponding to the window having focus.

13. The display system of claim 12, wherein, in response to a user command changing focus to a second one of the windows:
the window projector displays, at a display location for the second window, a portion of the image corresponding to the second window; and
the workspace projector displays the remainder of the image.

14. The display system of claim 1, wherein the workspace projector displays the remainder of the image while leaving blank an area of the image corresponding to the display location of the window.

15. The display system of claim 14, wherein, the workspace projector performs at least one of moving and resizing the blank area of the image so as to correspond to the changed at least one of the display location and size of the window.

16. The display system of claim 1, wherein the control mechanism changes the display location of the window portion of the image by repositioning the window projector.

17. The display system of claim 1, further comprising a mirror for directing the output of the window projector to the display location, and wherein the control mechanism changes the display location of the window portion of the image by repositioning the mirror.

18. The display system of claim 1, wherein the control mechanism changes the size of the window portion of the image in response to a user command for resizing the window.

19. The display system of claim 1, wherein the control mechanism comprises:
a pan/tilt control mechanism; and
a zoom control mechanism.

20. A multi-projector display system for displaying an image including at least two windows, comprising:
a plurality of window projectors, each for displaying, at a display location, a portion of the image corresponding to a window;
a workspace projector, for displaying the remainder of the image; and
at least one control mechanism, coupled to the window projectors, for changing at least one of the display locations and the sizes of the window portions of the image.

21. The display system of claim 20, wherein the at least one control mechanism changes the at least one of the display locations and the sizes of the window portions of the image in response to user commands.

22. A multi-projector display system for displaying an image including at least one window, comprising:
a window projector, for displaying, at a display location, a portion of the image corresponding to a window;
a plurality of workspace projectors, for collectively displaying the remainder of the image; and
at least one control mechanism, coupled to the window projector, for changing at least one of the display location and the size of the window portion of the image.

23. The display system of claim 22, wherein the at least one control mechanism changes the at least one of the display location and the size of the window portion of the image in response to a user command.

24. The display system of claim 22, wherein the window projector displays the portion of the image corresponding to a window without any visible seams.

25. A multi-projector display system for displaying an image including at least one window, comprising:
a plurality of window projectors, each for displaying, at a display location, a portion of the image corresponding to a window;
a plurality of workspace projectors, for collectively displaying the remainder of the image; and
at least one control mechanism, coupled to the window projectors, for changing at least one of the display locations and the sizes of the window portions of the image.

26. The display system of claim 25, wherein the at least one control mechanism changes the at least one of the display locations and the sizes of the window portions of the image in response to user commands.

27. A display system for displaying an image including at least one window, comprising:
a display device, for displaying a portion of the image omitting an area corresponding to a window;
a window projector, for projecting onto the display device, at a display location corresponding to the area omitted by the display device, the portion of the image corresponding to the area omitted by the display device;
a mechanism, coupled to the window projector, for changing at least one of the display location and the size of the display location of the window portion of the image.

28. The display system of claim 27, wherein the control mechanism changes the at least one of the display location and the size of the window portion of the image in response to a user command.

29. A multi-projector display system for displaying an image, comprising:
at least one regional image source, each for providing a portion of the image corresponding to a display region;
a workspace image source, for providing the remainder of the image;
at least one regional projector, each coupled to a regional image source, each for displaying the provided portion of the image at the display region;
a workspace projector, coupled to the workspace image source, for displaying the remainder of the image; and
at least one control mechanism, coupled to the at least one regional projector, for changing the location of the at least one display region.

30. A multi-projector display method for displaying an image including at least one window, comprising:
displaying, by a window projector, at a display location, a portion of the image corresponding to a window;
displaying, by a workspace projector, the remainder of the image; and
changing at least one of the display location and the size of the display location of the window portion of the image.

31. The display method of claim 30, wherein changing the at least one of the display location and the size comprises changing the at least one of the display location and the size in response to a user command.

32. The display method of claim 30, wherein changing the at least one of the display location and the size comprises changing the display location in response to a user command for moving the window.

33. The display method of claim 30, wherein changing the at least one of the display location and the size comprises changing the display location in response to activation of the window.

34. The display method of claim 30, wherein:
displaying the window portion of the image comprises displaying the window portion of the image at a first level of resolution; and
displaying the remainder of the image comprises displaying the remainder of the image at a second level of resolution.

35. The display method of claim 34, wherein the first level of resolution is greater than the second level of resolution.

36. The display method of claim 30, wherein:
displaying the window portion of the image comprises displaying the window portion of the image in a first visual format; and
displaying the remainder of the image comprises displaying the remainder of the image in a second visual format;
wherein the first visual format is distinct from the second visual format.

37. The display method of claim 36, wherein the first visual format is color and the second visual format is monochrome.

38. The display method of claim 30, wherein displaying a portion of the image corresponding to a movable window comprises displaying a motion picture in the window portion of the image.

39. The display method of claim 30, wherein the image includes a plurality of windows, one of the windows currently having focus, and wherein displaying a portion of the image corresponding to a window comprises displaying the portion of the image corresponding to the window having focus.

40. The display method of claim 39, further comprising, in response to a user command changing focus to a second one of the windows:
displaying, by the window projector, at a display location for the second window, a portion of the image corresponding to the second window; and
displaying, by the workspace projector, the remainder of the image.

41. The display method of claim 30, wherein displaying the remainder of the image comprises leaving blank an area of the image corresponding to the display location of the window.

42. The display method of claim 41, further comprising, in response to the user command for moving the window, moving the blank area of the image so as to correspond to the changed display location of the window.

43. The display method of claim 30, wherein changing the display location of the window portion of the image comprises repositioning the window projector.

44. The display method of claim 30, wherein changing the display location of the window portion of the image comprises repositioning a mirror.

45. The display method of claim 30, further comprising changing the size of the window portion of the image in response to a user command for resizing the window.
